(19) United States
(12) Patent Application Publication
(10) Pub. No.: US 2026/0133580 A1
(43) Pub. Date: May 14, 2026

(54) SCENE RECOGNITION METHOD, ROBOT, AND COMPUTER-READABLE STORAGE MEDIUM

(71) Applicant: UBTECH ROBOTICS CORP LTD, Shenzhen (CN)

(72) Inventors: Jiahao JI, Shenzhen (CN); Jichao Jiao, Shenzhen (CN)

(21) Appl. No.: 19/435,753

(22) Filed: Dec. 30, 2025

Related U.S. Application Data
(63) Continuation of application No. PCT/CN2023/141350, filed on Dec. 25, 2023.

(30) Foreign Application Priority Data
Oct. 20, 2023 (CN) 202311373728.4

(51) Int. Cl. G05D 1/246; G01S 17/89; G05D 109/10; G05D 111/10; G06V 10/44; G06V 10/75; G06V 20/56

(52) U.S. Cl. CPC G05D 1/246; G01S 17/89; G06V 10/44; G06V 10/751; G06V 20/56; G05D 2109/10; G05D 2111/17

(57) ABSTRACT

A scene recognition method, a robot, and a computer-readable storage medium are provided. The method includes: obtaining, through the laser radar device of the robot, laser point cloud data of the robot; obtaining a target scene image corresponding to the laser point cloud data by performing an image mapping on the laser point cloud data; calculating a graphic complexity corresponding to the target scene image; and determining, based on the graphic complexity, the scene where the robot is located. In this manner, the graphic complexity corresponding to the target scene image can be calculated, and the scene where the robot is located can be determined based on the graphic complexity, thereby using appropriate reposition method in different scenarios to improve the robustness and scene adaptability of the robot.

### CROSS REFERENCE TO RELATED APPLICATIONS

The present disclosure is a continuation-application of International Application PCT/CN2023/141350, with an international filing date of Dec. 25, 2023, which claims foreign priority of Chinese Patent Application No. 202311373728.4, filed on Oct. 20, 2023 in the State Intellectual Property Office of China, the contents of all of which are hereby incorporated by reference.

### TECHNICAL FIELD

The present disclosure relates to robotics technology, and particularly to a scene recognition method, a robot, and a computer-readable storage medium.

### BACKGROUND

With the development of technology, more and more robots have been used in various fields. When a robot operates, if it is moved artificially, it will need to be repositioned. Usually, the robot will rotate in place, obtain multiple frames of laser point cloud data and the existing map for template matching, thereby obtaining new positioning information. However, in the case that the robot is in a complex scene that, for example, there are multiple obstacles around the laser source, if the reposition continues to be used, a lot of laser point cloud data behind the obstacles could be missing, which results in reposition failure. Therefore, an accurate and efficient scene recognition method is essential for the reposition of the robot.

In view of this, the present disclosure provides a scene recognition method, a robot, and a computer-readable storage medium to perform scene recognition, thereby improving the robustness of the reposition of the robot.

### BRIEF DESCRIPTION OF DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a schematic diagram of scenes where a robot is located according to an embodiment of the present disclosure.

FIG. 2 is a flow chart of a scene recognition method according to an embodiment of the present disclosure.

FIG. 3 is a schematic diagram of a target scene image according to an embodiment of the present disclosure.

FIG. 4 is a schematic diagram of a converted image according to an embodiment of the present disclosure.

FIG. 5 is a schematic diagram of an edge image according to an embodiment of the present disclosure.

FIG. 6 is a flow chart of a complexity threshold calculation according to an embodiment of the present disclosure.

FIG. 7 is a schematic diagram of the structure of a scene recognition device according to an embodiment of the present disclosure.

FIG. 8 is a schematic diagram of a robot according to an embodiment of the present disclosure.

### DETAILED DESCRIPTION

In order to make the objects, features and advantages of the present disclosure more obvious and easy to understand, the technical solutions in the embodiments of the present disclosure will be clearly and completely described below with reference to the drawings. Apparently, the described embodiments are part of the embodiments of the present disclosure, not all of the embodiments. All other embodiments obtained by those skilled in the art based on the embodiments of the present disclosure without creative efforts are within the scope of the present disclosure.

It is to be understood that, when used in the description and the appended claims of the present disclosure, the terms “including” and “comprising” indicate the presence of stated features, integers, steps, operations, elements and/or components, but do not preclude the presence or addition of one or a plurality of other features, integers, steps, operations, elements, components and/or combinations thereof.

It is also to be understood that, the terminology used in the description of the present disclosure is only for the purpose of describing particular embodiments and is not intended to limit the present disclosure. As used in the description and the appended claims of the present disclosure, the singular forms “one”, “a”, and “the” are intended to include the plural forms as well, unless the context clearly indicates otherwise.

It is also to be further understood that the term “and/or” used in the description and the appended claims of the present disclosure refers to any combination of one or more of the associated listed items and all possible combinations, and includes such combinations.

As used in the description and the appended claims, the term “if” may be interpreted as “when” or “once” or “in response to determining” or “in response to detecting” according to the context. Similarly, the phrase “if determined” or “if [the described condition or event] is detected” may be interpreted as “once determining” or “in response to determining” or “on detection of [the described condition or event]” or “in response to detecting [the described condition or event]”.

In addition, in the present disclosure, the terms “first”, “second”, “third”, and the like in the descriptions are only used for distinguishing, and cannot be understood as indicating or implying relative importance.

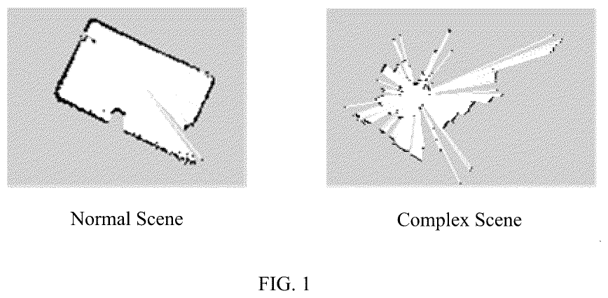

With the development of technology, more and more robots have been used in various fields. When a robot operates, if it is moved artificially, it will need to be repositioned. Usually, the robot will rotate in place, obtain multiple frames of laser point cloud data and the existing map for template matching, thereby obtaining new positioning information. In the case that the robot is in a normal scene, the detected obstacle (e.g., a wall or sofa against the wall) may have no other features in its behind. In this case, the laser point cloud data behind the obstacle will not miss a lot due to the obstruction by obstacles, hence the reposition method can effectively perform repositions. FIG. 1 is a schematic diagram of scenes where a robot is located according to an embodiment of the present disclosure. As shown in FIG. 1, in the case that the robot is in a complex scene, the laser point cloud data behind the obstacles could miss a lot, which results in reposition failures.

In view of this, in this embodiment, a scene recognition method, a robot, and a computer-readable storage medium are provided to solve the problem of robots easily failing to reposition in the complex scenes.

It should be noted that the subject of executing the methods of the present disclosure is a robot, which may specifically include sweeping machine, floor washing machine, inspection robot, guidance robot, food delivery robot, humanoid robot, or other common robots in the existing technology.

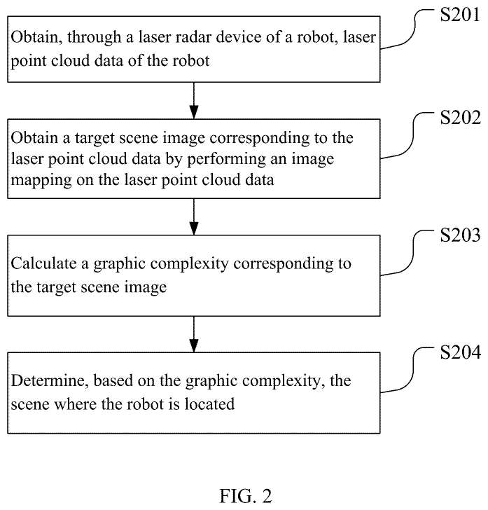

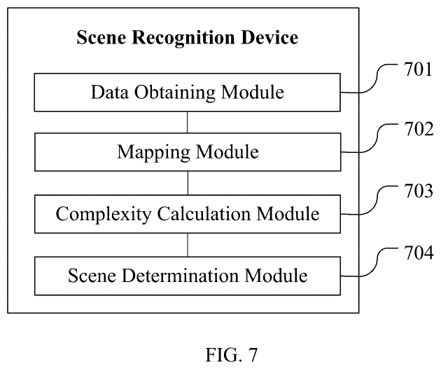

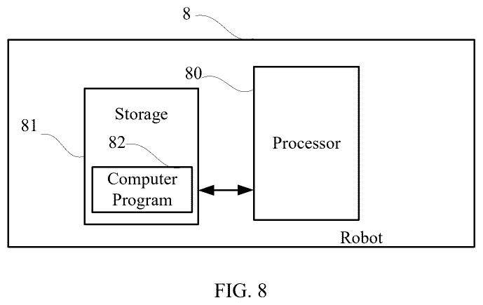

FIG. 2 is a flow chart of a scene recognition method according to an embodiment of the present disclosure. In this embodiment, the scene recognition method may be applied to (a processor of) the robot. The robot has a laser radar device such as a lidar. In other embodiments, the method may be implemented through a scene recognition device as shown in FIG. 7 or a robot as shown in FIG. 8. As shown in FIG. 2, the scene recognition method may include the following steps.

S201: obtaining, through the laser radar device of the robot, laser point cloud data of the robot.

In this embodiment, it may obtain the laser point cloud data by detecting and scanning the surrounding environment of the robot through the laser radar device. On this basis, the surrounding environment information of the robot can be obtained.

Specifically, the robot is typically installed with the laser radar device to realize functions such as map detection, navigation, and obstacle avoidance. When scene recognition is required, the robot can be controlled to rotate in place so that the laser radar device can collect the laser point cloud data in real time. Then, the laser point cloud data may be stored in a storage module, so that the laser point cloud data of the robot can be obtained through storage module.

S202: obtaining a target scene image corresponding to the laser point cloud data by performing an image mapping on the laser point cloud data.

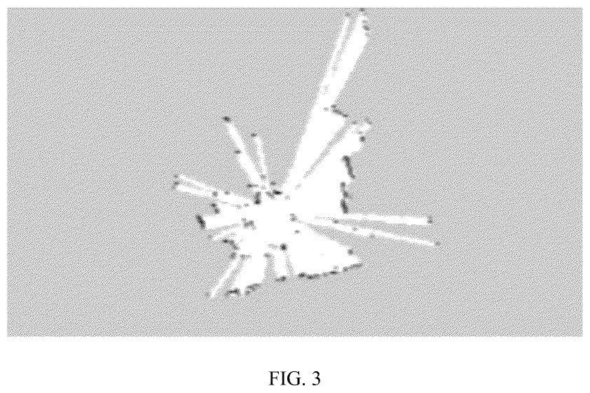

In this embodiment, it may perform the image mapping on the laser point cloud data to enhance the visualization level of the laser point cloud data, thereby improving the efficiency of subsequent processing. FIG. 3 is a schematic diagram of a target scene image according to an embodiment of the present disclosure. As shown in FIG. 3, the known areas in the laser point cloud data may be set as white pixels, the obstacle in the laser point cloud data may be set as black pixels, and the unknown areas in the laser point cloud data may be set as gray pixels, thereby obtaining the target scene image corresponding to the laser point cloud data.

In actual applications, it may perform the image mapping on the laser point cloud data according to actual needs.

S203: calculating a graphic complexity corresponding to the target scene image.

In this embodiment, whether the robot is in the complex scene may be determined based on the compactness of the graphic composed of the laser point cloud data. In which, the perimeter-to-area ratio of the known areas in the target scene image may be calculated.

It should be noted that different colored pixels may be used to represent different areas in the target scene image, thereby facilitating differentiation and processing. In which, the white pixels may be used to represent the known areas, the black pixels may be used to represent the obstacles, and the gray pixels may be used to represent the unknown areas.

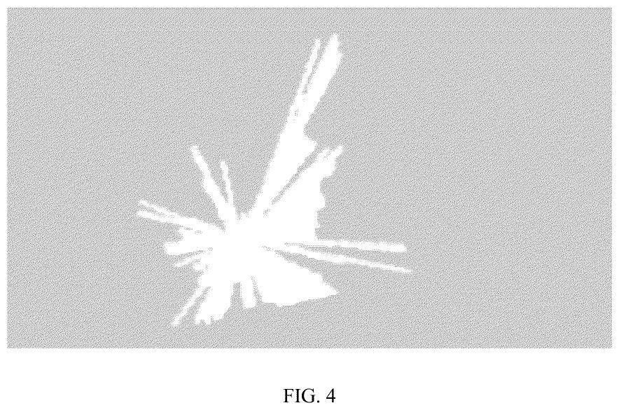

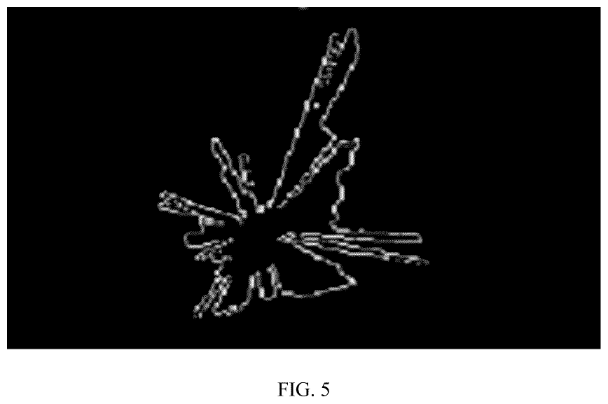

FIG. 4 is a schematic diagram of a converted image according to an embodiment of the present disclosure. As shown in FIG. 4, specifically, the first number of the white pixels (i.e., the area of the known areas) in the target scene image may be counted, then the black pixels in the target scene image may be converted into the white pixels to obtain the converted image. FIG. 5 is a schematic diagram of an edge image according to an embodiment of the present disclosure. As shown in FIG. 5, a preset edge extraction algorithm may be used to perform the edge extraction on the converted image to obtain the edge image. Then, the second number of the edge pixels (i.e., the perimeter of the known area) in the edge image may be counted, and the graphic complexity corresponding to the target scene image may be calculated based on the first number and the second number.

In this embodiment, the ratio ratio of the second number to the first number may be calculated as an equation of:

$$ratio = c / s ;$$

then, the ratio may be used as the graphic complexity corresponding to the target scene image.

In which, the above-mentioned edge extraction algorithm may be any common edge extraction algorithm in the existing technology, which may include Canny edge detection operator, Roberts edge detection operator, Sobel edge detection operator, Prewitt edge detection operator, Laplacian edge detection operator, or other common edge detection algorithms.

S204: determining, based on the graphic complexity, the scene where the robot is located.

In this embodiment, if the graphic complexity is larger than a preset complexity threshold, it may be considered that the compactness of the graphics in the known area is low like the complex scene shown in FIG. 1, and therefore it may be determined that the scene where the robot is located is the complex scene; otherwise, if the graphic complexity is less than or equal to the complexity threshold, it may be considered that the compactness of the graphics in the known area is high like the normal scene shown in FIG. 1. Therefore, it may be determined that the scene where the robot is located is the normal scene. In which, the complexity threshold may be specifically and contextualize set according to actual needs. For example, it may be set to 0.1, 0.15, 0.2, or other values.

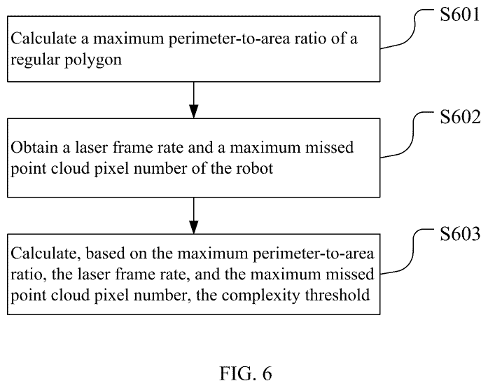

FIG. 6 is a flow chart of a complexity threshold calculation according to an embodiment of the present disclosure. As shown in FIG. 6, in this embodiment, the complexity threshold may be calculated based on the maximum perimeter-to-area ratio, the laser frame rate and the maximum missed point cloud pixel number. Specifically, the calculation process of the complexity threshold may include the following steps:

S601: calculating a maximum perimeter-to-area ratio of a regular polygon.

In this embodiment, it may obtain the maximum effective distance of the laser of the robot and the map resolution. In which, the maximum effective distance of the laser is the maximum effective detection distance of the laser radar device, and the map resolution is the actual distance represented by each pixel on the map. For example, if the map resolution is 0.05, it may mean that the actual distance represented by one pixel on the map is 0.05 meter.

In which, the regular polygon may be used as the reference graph for calculating the complexity threshold, and the maximum effective distance of the laser of the robot may be used as the reference side length of the regular polygon. Based on the maximum effective distance of the laser and the map resolution, the number of pixels of the side length of the regular polygon in the scene image may be calculated as an equation of:

$$d = L \div r ;$$

where, d is the number of the pixels of the side length of the regular polygon, L is the maximum effective distance of the laser, and r is the map resolution.

According to the side length d of the regular polygon, the perimeter c_of the regular polygon may be calculated as an equation of:

$$c\_ = n \times d ;$$

where, n is the number of the side lengths of the regular polygon.

In addition, the area s_of the regular polygon may also be calculated as an equation of:

$$s\_ = 0.25 \times n \times {d}^{2} \times cot ( π / n ) ;$$

where, n is the number of the side lengths of the regular polygon. Based on this, the perimeter-to-area ratio ratio_of the regular polygon may be calculated as an equation of:

$$ratio\_ = c\_ / \text{s\_.}$$

By substituting the calculation formulas for the perimeter c_of the regular polygon and the area s_of the regular polygon into the foregoing equation, it can obtain:

$$ratio\_ = c\_ / s\_ = n \times d / 0.25 \times n \times {d}^{2} \times cot ( π / n ) = 4 tan ( π / n ) / d .$$

It should be noted that the lower the compactness of the graphic is (i.e., the higher the degree of divergence), the larger the corresponding perimeter-to-area ratio; otherwise, the higher the compactness of the graphic is (i.e., the lower the degree of divergence), the smaller the corresponding perimeter-to-area ratio. Therefore, in this embodiment, the complexity threshold may be calculated based on the highest degree of compactness (i.e., the maximum perimeter-to-area ratio) that the known area could achieve in the normal scenario.

Specifically, since the value of tan(π/n) is (0,1), and it may generally be considered that the graph detected by the laser radar device has at least 4 sides, that is, n≥4. Therefore, the maximum value of tan(π/n) may be 1, and the maximum perimeter-to-area ratio ratio_max of the regular polygon may be as an equation of:

$$ratio\_ max = 4 / d .$$

S602: obtaining a laser frame rate and a maximum missed point cloud pixel number of the robot.

In this embodiment, when calculating the complexity threshold, the laser frame rate f and the maximum missed point cloud pixel number α of the robot may also be obtained according to the actual needs. In which, the laser frame rate f is the number of frames of the laser point cloud data collected per second, and the maximum missed point cloud pixel number α is the maximum tolerable number of the missed point cloud pixels.

It should be noted that the laser frame rate of the robot is negatively related to the perimeter-to-area ratio of the regular polygon. The larger the laser frame rate of the robot, the smaller the perimeter-to-area ratio of the regular polygon; otherwise, the smaller the laser frame rate of the robot, the smaller the perimeter-to-area ratio of the regular polygon. The maximum missed point cloud pixel number is positively related to the perimeter-to-area ratio of the regular polygon. The larger the maximum missed point cloud pixel number, the larger the perimeter-to-area ratio of the regular polygon; otherwise, the smaller the maximum missed point cloud pixel number, the smaller the perimeter-to-area ratio of the regular polygon.

S603: calculating, based on the maximum perimeter-to-area ratio, the laser frame rate, and the maximum missed point cloud pixel number, the complexity threshold.

In this embodiment, the complexity threshold may be calculated based on the maximum perimeter-to-area ratio, the laser frame rate, and the maximum missed point cloud pixel number, as an equation of.

$$ratio\_threshold = \frac{α}{f} \times ratio\_max = α \times \frac{4}{f \times d}$$

where, ratio_threshold is the complexity threshold. The value of the maximum missed point cloud pixel number α may be specific and contextualized set according to actual needs, for example, set to 40.

For example, the maximum effective distance of the laser of the robot is 6.5 meters, the map resolution is 0.05, and the laser frame rate f is 6 (i.e., 6 frames of the laser point cloud data can be collected per second). Based on the foregoing process, the complexity threshold ratio_threshold may be calculated to be 0.205.

In this embodiment, it should be noted that after determining the scene where the robot is located according to the graphic complexity, a target reposition algorithm corresponding to the scene where the robot is located may also be determined, and the target reposition algorithm may be used to reposition the robot to obtain a reposition result. Specifically, in the case that the robot is in a normal scene, a traditional laser reposition algorithm may be determined as the target reposition algorithm. At this time, the robot may be controlled to rotate in place to obtain the laser point cloud data so as to perform template matching with the existing map, thereby obtaining the reposition result; otherwise, in the case that the robot is in a complex scene, other sensors and a corresponding reposition method may be used for reposition. For one example, the ultrasonic reposition method may be determined as the target reposition algorithm. At this time, the position of the robot may be determined by comparing the distance between the robot and each preset calibration object using the reflection and propagation characteristics of ultrasound signals. For another example, the reposition algorithm of Radio Frequency Identification (RFID) may be determined as the target reposition algorithm. At this time, it may install RFID tags on the robot and each preset calibration object, and use wireless communication to read the tag information to determine the distance between the robot and each calibration object, thereby calculating the position the of robot. For still another example, a reposition algorithm that combines multiple sensors may be determined as the target reposition algorithm. Specifically, infrared sensors and geomagnetic sensors may be used to obtain the position information of the robot, and the position and posture of the robot may be calculated by processing and analyzing the data of the infrared sensors and the geomagnetic sensors, thereby repositioning the robot.

In this manner, an appropriate reposition algorithm can be flexibly selected according to the actual scene in which the robot is located, thereby improving the robustness and scene adaptability of the reposition of the robot, which helps improving the user experience.

To sum up, in this embodiment, by obtaining, through the laser radar device of the robot, laser point cloud data of the robot; obtaining a target scene image corresponding to the laser point cloud data by performing an image mapping on the laser point cloud data; calculating a graphic complexity corresponding to the target scene image; and determining, based on the graphic complexity, the scene where the robot is located, the graphic complexity corresponding to the target scene image can be calculated, and the scene where the robot is located can be determined based on the graphic complexity, thereby using appropriate reposition method in different scenarios to improve the robustness and scene adaptability of the robot.

It should be noted that, the serial number of the steps in the above-mentioned embodiments does not mean the execution order while the execution order of each process should be determined by its function and internal logic, which should not be taken as any limitation to the implementation process of the embodiments.

FIG. 7 is a schematic diagram of the structure of a scene recognition device according to an embodiment of the present disclosure. As shown in FIG. 7, in this embodiment, a scene recognition device corresponding to the scene recognition method in the foregoing embodiment is provided.

In this embodiment, a scene recognition device may include:
a data obtaining module 701 configured to obtain, through the laser radar device of the robot, laser point cloud data of the robot;
a mapping module 702 configured to obtain a target scene image corresponding to the laser point cloud data by performing an image mapping on the laser point cloud data;
a complexity calculation module 703 configured to calculate a graphic complexity corresponding to the target scene image; and
a scene determination module 704 configured to determine, based on the graphic complexity, the scene where the robot is located.

In one embodiment, the complexity calculation module 703 may include:
a first number counting submodule configured to count a first number of white pixels in the target scene image, wherein the white pixels represent known areas;
a pixel conversion submodule configured to obtain a converted image by converting black pixels in the target scene image into the white pixels, wherein the black pixels represent obstacles;
an edge extraction submodule configured to obtain an edge image by performing an edge extraction on the converted image;
a second number counting submodule configured to count a second number of edge pixels in the edge image; and
a complexity calculation submodule configured to calculate, based on the first number and the second number, the graphic complexity corresponding to the target scene image.

In one embodiment, the complexity calculation submodule may include:
a ratio calculation unit configured to calculate a ratio of the second number to the first number; and
a complexity determination unit configured to use the ratio as the graphic complexity corresponding to the target scene image.

In one embodiment, the scene determination module 704 may include:
a complex scene determining submodule configured to determine the scene where the robot is located as a complexity scene, in response to the graph complexity being larger than a preset complexity threshold; and
a normal scene determining submodule configured to determine the scene where the robot is located as a normal scene, in response to the graph complexity being less than or equal to the complexity threshold.

In one embodiment, the scene recognition device may further include:
a maximum value calculating module configured to calculate a maximum perimeter-to-area ratio of a regular polygon;
a frame rate obtaining module configured to obtain a laser frame rate and a maximum missed point cloud pixel number of the robot; and
a complexity threshold calculating module configured to calculate, based on the maximum perimeter-to-area ratio, the laser frame rate, and the maximum missed point cloud pixel number, the complexity threshold.

In one embodiment, the maximum value calculating module may include:
a resolution obtaining submodule configured to obtain a maximum laser effective distance and a map resolution of the robot;
a side length calculating submodule configured to calculating, based on the maximum laser effective distance and the map resolution, a side length of the regular polygon; and
a maximum value calculating submodule configured to calculating, based on the side length of the regular polygon, the maximum perimeter-to-area ratio.

In one embodiment, the scene recognition device may further include:
a reposition algorithm determining module configured to determining a target re-positioning algorithm corresponding to the scene where the robot is located; and
a reposition module configured to obtain a re-positioning result by re-positioning the robot using the target re-positioning algorithm.

Those skilled in the art may clearly understand that, for the convenience and simplicity of description, for the specific operation process of the above-mentioned apparatus, modules, and units, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

FIG. 8 is a schematic diagram of a robot according to an embodiment of the present disclosure. As shown in FIG. 8, in this embodiment, the robot 8 includes a processor 80, a storage 81, and a computer program 82 stored in the storage 81 and executable on the processor 80. When executing (instructions in) the computer program 82, the processor 80 implements the steps in the above-mentioned embodiments of the scene recognition method, for example, steps S201-S204 shown in FIG. 2. Alternatively, when the processor 80 executes the (instructions in) computer program 82, the functions of each module/unit in the above-mentioned device embodiments, for example, the functions of the modules 701-704 shown in FIG. 7 are implemented.

Exemplarily, the computer program 82 may be divided into one or more modules/units, and the one or more modules/units are stored in the storage 81 and executed by the processor 80 to realize the present disclosure. The one or more modules/units may be a series of computer program instruction sections capable of performing a specific function, and the instruction sections are for describing the execution process of the computer program 82 in the robot 8.

It can be understood by those skilled in the art that FIG. 8 is merely an example of the robot 8 and does not constitute a limitation on the robot 8, and may include more or fewer components than those shown in the figure, or a combination of some components or different components. For example, the robot 8 may further include an input/output device, a network access device, a bus, and the like.

The processor 80 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 81 may be an internal storage unit of the robot 8, for example, a hard disk or a memory of the robot 8. The storage 81 may also be an external storage device of the robot 8, for example, a plug-in hard disk, a smart media card (SMC), a secure digital (SD) card, flash card, and the like, which is equipped on the robot 8. Furthermore, the storage 81 may further include both an internal storage unit and an external storage device, of the robot 8. The storage 81 is configured to store the computer program 82 and other programs and data required by the robot 8. The storage 81 may also be used to temporarily store data that has been or will be output.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/robot and method may be implemented in other manners. For example, the above-mentioned apparatus/robot embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer readable storage medium. Based on this understanding, all or part of the processes in the method for implementing the above-mentioned embodiments of the present disclosure are implemented, and may also be implemented by instructing relevant hardware through a computer program. The computer program may be stored in a non-transitory computer readable storage medium, which may implement the steps of each of the above-mentioned method embodiments when executed by a processor. In which, the computer program includes computer program codes which may be the form of source codes, object codes, executable files, certain intermediate, and the like. The computer readable medium may include any entity or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A method for recognizing a scene where a robot having a laser radar device is located, comprising:
obtaining, through the laser radar device of the robot, laser point cloud data of the robot;
obtaining a target scene image corresponding to the laser point cloud data by performing an image mapping on the laser point cloud data;
calculating a graphic complexity corresponding to the target scene image; and
determining, based on the graphic complexity, the scene where the robot is located.

2. The method of claim 1, wherein calculating the graphic complexity corresponding to the target scene image comprises:
counting a first number of white pixels in the target scene image, wherein the white pixels represent known areas;
obtaining a converted image by converting black pixels in the target scene image into the white pixels, wherein the black pixels represent obstacles;
obtaining an edge image by performing an edge extraction on the converted image;
counting a second number of edge pixels in the edge image; and
calculating, based on the first number and the second number, the graphic complexity corresponding to the target scene image.

3. The method of claim 2, wherein calculating, based on the first number and the second number, the graphic complexity corresponding to the target scene image comprises:
calculating a ratio of the second number to the first number; and
using the ratio as the graphic complexity corresponding to the target scene image.

4. The method of claim 1, wherein determining, based on the graphic complexity, the scene where the robot is located comprises:
determining the scene where the robot is located as a complexity scene, in response to the graph complexity being larger than a preset complexity threshold; and
determining the scene where the robot is located as a normal scene, in response to the graph complexity being less than or equal to the complexity threshold.

5. The method of claim 4, wherein before calculating, based on the first number and the second number, the graphic complexity corresponding to the target scene image, further comprising:
calculating a maximum perimeter-to-area ratio of a regular polygon;
obtaining a laser frame rate and a maximum missed point cloud pixel number of the robot; and
calculating, based on the maximum perimeter-to-area ratio, the laser frame rate, and the maximum missed point cloud pixel number, the complexity threshold.

6. The method of claim 5, wherein calculating the maximum perimeter-to-area ratio of the regular polygon comprises:
obtaining a maximum laser effective distance and a map resolution of the robot;
calculating, based on the maximum laser effective distance and the map resolution, a side length of the regular polygon; and
calculating, based on the side length of the regular polygon, the maximum perimeter-to-area ratio.

7. The method of claim 1, wherein after calculating, based on the first number and the second number, the graphic complexity corresponding to the target scene image, further comprising:
determining a target re-positioning algorithm corresponding to the scene where the robot is located; and
obtaining a re-positioning result by re-positioning the robot using the target re-positioning algorithm.

8. A robot, comprising:
a laser radar device;
a processor;
a memory coupled to the processor; and
one or more computer programs stored in the memory and executable on the processor;
wherein, the one or more computer programs comprise:
instructions for obtaining, through the laser radar device of the robot, laser point cloud data of the robot;
instructions for obtaining a target scene image corresponding to the laser point cloud data by performing an image mapping on the laser point cloud data;
instructions for calculating a graphic complexity corresponding to the target scene image; and
instructions for determining, based on the graphic complexity, a scene where the robot is located.

9. The robot of claim 8, wherein the instructions for calculating the graphic complexity corresponding to the target scene image comprise:
instructions for counting a first number of white pixels in the target scene image, wherein the white pixels represent known areas;
instructions for obtaining a converted image by converting black pixels in the target scene image into the white pixels, wherein the black pixels represent obstacles;
instructions for obtaining an edge image by performing an edge extraction on the converted image;
instructions for counting a second number of edge pixels in the edge image; and
instructions for calculating, based on the first number and the second number, the graphic complexity corresponding to the target scene image.

10. The robot of claim 9, wherein the instructions for calculating, based on the first number and the second number, the graphic complexity corresponding to the target scene image comprise:
instructions for calculating a ratio of the second number to the first number; and
instructions for using the ratio as the graphic complexity corresponding to the target scene image.

11. The robot of claim 8, wherein the instructions for determining, based on the graphic complexity, the scene where the robot is located comprise:
instructions for determining the scene where the robot is located as a complexity scene, in response to the graph complexity being larger than a preset complexity threshold; and
instructions for determining the scene where the robot is located as a normal scene, in response to the graph complexity being less than or equal to the complexity threshold.

12. The robot of claim 11, wherein the one or more computer programs further comprise:
instructions for calculating a maximum perimeter-to-area ratio of a regular polygon;
instructions for obtaining a laser frame rate and a maximum missed point cloud pixel number of the robot; and
instructions for calculating, based on the maximum perimeter-to-area ratio, the laser frame rate, and the maximum missed point cloud pixel number, the complexity threshold.

13. The robot of claim 12, wherein the instructions for calculating the maximum perimeter-to-area ratio of the regular polygon comprise:
instructions for obtaining a maximum laser effective distance and a map resolution of the robot;
instructions for calculating, based on the maximum laser effective distance and the map resolution, a side length of the regular polygon; and
instructions for calculating, based on the side length of the regular polygon, the maximum perimeter-to-area ratio.

14. The robot of claim 8, wherein the one or more computer programs further comprise:
instructions for determining a target re-positioning algorithm corresponding to the scene where the robot is located; and
instructions for obtaining a re-positioning result by re-positioning the robot using the target re-positioning algorithm.

15. A non-transitory computer-readable storage medium for storing one or more computer programs, wherein the one or more computer programs comprise:
instructions for obtaining, through a laser radar device of a robot, laser point cloud data of the robot;
instructions for obtaining a target scene image corresponding to the laser point cloud data by performing an image mapping on the laser point cloud data;
instructions for calculating a graphic complexity corresponding to the target scene image; and
instructions for determining, based on the graphic complexity, a scene where the robot is located.

16. The storage medium of claim 15, wherein the instructions for calculating the graphic complexity corresponding to the target scene image comprise:
instructions for counting a first number of white pixels in the target scene image, wherein the white pixels represent known areas;
instructions for obtaining a converted image by converting black pixels in the target scene image into the white pixels, wherein the black pixels represent obstacles;
instructions for obtaining an edge image by performing an edge extraction on the converted image;
instructions for counting a second number of edge pixels in the edge image; and
instructions for calculating, based on the first number and the second number, the graphic complexity corresponding to the target scene image.

17. The storage medium of claim 16, wherein the instructions for calculating, based on the first number and the second number, the graphic complexity corresponding to the target scene image comprise:
instructions for calculating a ratio of the second number to the first number; and
instructions for using the ratio as the graphic complexity corresponding to the target scene image.

18. The storage medium of claim 15, wherein the instructions for determining, based on the graphic complexity, the scene where the robot is located comprise:
instructions for determining the scene where the robot is located as a complexity scene, in response to the graph complexity being larger than a preset complexity threshold; and
instructions for determining the scene where the robot is located as a normal scene, in response to the graph complexity being less than or equal to the complexity threshold.

19. The storage medium of claim 18, wherein the one or more computer programs further comprise:
instructions for calculating a maximum perimeter-to-area ratio of a regular polygon;
instructions for obtaining a laser frame rate and a maximum missed point cloud pixel number of the robot; and
instructions for calculating, based on the maximum perimeter-to-area ratio, the laser frame rate, and the maximum missed point cloud pixel number, the complexity threshold.

20. The storage medium of claim 19, wherein the instructions for calculating the maximum perimeter-to-area ratio of the regular polygon comprise:
instructions for obtaining a maximum laser effective distance and a map resolution of the robot;
instructions for calculating, based on the maximum laser effective distance and the map resolution, a side length of the regular polygon; and
instructions for calculating, based on the side length of the regular polygon, the maximum perimeter-to-area ratio.
